(19) United States
(12) Patent Application Publication
(10) Pub. No.: US 2010/0033308 A1
(43) Pub. Date: Feb. 11, 2010

(54) ARRANGEMENT FOR DOCUMENTING THE STATUS OF REMOVABLE PARTS ON BOARD AN AIRCRAFT

(75) Inventor: Andrew Muirhead, Norderstedt (DE)

Correspondence Address: MORRISON & FOERSTER LLP, 1650 TYSONS BOULEVARD, SUITE 400, MCLEAN, VA, 22102, US

(73) Assignee: Lufthansa Technik AG, Hamburg (DE)

(21) Appl. No.: 12/517,007

(22) PCT Filed: Nov. 30, 2007
(86) PCT No.: PCT/EP2007/010435

§ 371 Date: May 29, 2009

(30) Foreign Application Priority Data
Nov. 30, 2006 (EP) 06024829.1

(51) Int. Cl. H04Q 5/22; G06F 7/00

(52) U.S. Cl. 340/10.1; 340/5.92

(57) ABSTRACT

A system for documenting the status of removable parts on board an aircraft, in which at least some of the removable parts are provided with a passive storage to which and from which data can be read in a contactless manner, includes at least one reading device for contactlessly reading data from the passive storage means is provided on board the aircraft, at least one central memory on board the aircraft for storing or archiving the data which have been read from the passive storage by the at least one reading device which is connected to means for acquiring operating or flight data of the aircraft and a transmitting device on board the aircraft for transmitting the data from the central memory to a memory located outside the aircraft.

### REFERENCE TO RELATED APPLICATION

This application is the national stage under 35 USC 371 of International Application No. PCT/EP2007/010435, filed Nov. 30, 2007, which claims the priority of European Patent Application No. 06 024 829.1, filed Oct. 20, 2006, the entire contents of which are incorporated herein by reference.

### FIELD OF THE INVENTION

The invention relates to an arrangement for documenting the status of removable parts on board an aircraft, in which at least some of the removable parts are provided with a passive storage means to which and from which data can be read in a contactless manner.

### BACKGROUND OF THE INVENTION

Exchangeable aircraft parts and technical devices on board an aircraft (so-called removable parts) must be maintained or exchanged regularly. Such removable parts are provided with a so-called label which contains important information relating to this removable part in a visually readable manner.

From the American patent application US 2003/0187554, an arrangement is known in which individual exchangeable components, particularly in the area of the auxiliary power unit (APU), are provided with a computer chip on which various static label information items (serial number, manufacturer, etc.) and operational reports (operating hours, time of last maintenance etc.) can be stored. The communication for storing and retrieving this information is carried out via a cable-connected data bus and is monitored by a control module. The data can be used, on the one hand, by the electronic control unit (ECU) in order to check status information and performance characteristics and, on the other hand, they can be used by ground personnel during maintenance work and for checking the warranty. For this purpose, the data are transmitted to a ground station preferably already during the flight.

To avoid electromagnetic interference with the other aircraft instruments, it may be advantageous to send the data only after a defined operating state of the aircraft has occurred. Such an operating state can be, for example, the after-landing roll or the parking at the gate which, according to US 2003/0203734 can be determined, among other things, with a weight-on-wheels sensor or a cabin door sensor.

### SUMMARY OF THE INVENTION

The invention is based on the object of creating an arrangement or a system which provides for simple and reliable documentation of the status of removable parts on board an aircraft.

The arrangement according to the invention is characterized by the following features:

a) at least one reading device for contactlessly reading data from the passive storage means is provided on board the aircraft,

b) at least one central memory for storing and/or archiving the data which have been read from the passive storage means by means of the at least one reading device is provided on board the aircraft,

c) the central memory of the aircraft is additionally connected to means for acquiring operating and/or flight data of the aircraft,

d) a transmitting device for transmitting the data from the central memory to a memory which is arranged outside the aircraft is provided on board the aircraft.

Firstly, some terms used within the invention will be explained. Removable parts are all parts on board an aircraft which are removed and/or installed for maintenance purposes, repairs, for the purpose of exchanging the part or changing the aircraft configuration, particularly the cabin configuration, during the prescribed life cycle of the aircraft. According to the invention, all or some of the removable parts can be provided with the passive storage means, still to be explained. When selecting some of the removable parts, it is possible to concentrate, for example, on complex and/or high-maintenance removable parts, for example electrical and electronic devices which, for example, can be used for navigation and/or communication purposes or belong to the so-called cabin equipment and, for example, are used for entertainment purposes.

The removable parts are provided with a passive storage means to or from which data can be read in a contactless manner. A passive storage means only changes its state (i.e. the data stored therein) by influence from the outside. It has no devices for independently changing the information recorded therein. It is preferred if this passive storage means does not need its own energy source for operation.

The contactless reading-in and -out of data means that the data stored in the passive storage means can be read out or changed by suitable reading and writing devices which do not need to come into physical contact with the storage means for this purpose. It is particularly preferred if the contactless reading-in or -out can take place without visual contact between the passive storage means and the reading or writing device, that is to say does not take place optically. Due to the contactless reading of the data out of the passive storage means, it is possible to save cabling of the moving components. In particular, components which can be moved in the aircraft such as, e.g., fire extinguishers, rescue kits or trolleys can also be covered by the system according to the invention.

According to the invention, at least one reading device for reading data from the passive storage means is provided on board the aircraft. This reading device (or several reading devices) is or are preferably installed in the aircraft in such a manner that they can preferably read out all passive storage means of the removable parts without manual intervention (for example walking around with the reading device in the interior of the aircraft). In the case of the arrangement according to the invention, such a reading device is preferably permanently installed in the aircraft. This permanently installed reading device is exclusively constructed for reading data out of the passive storage means and should not change the data stored in the passive storage means.

Within the invention, it is also possible that the reading device is manually moved past the passive storage means for reading out the data. This can be done, for example, whenever the aircraft is parked at the gate.

At least one central memory for storing, preferably also for archiving data read out of the passive storage means by means of the at least one reading device is provided on board the aircraft. “Central” means that this memory combines, and provides for an access, the data read out of the passive storage means of several removable parts at one storage location.

Storing means that the data of the current aircraft configuration are kept available in the central memory over a relatively long period, for example until maintenance. The central memory can be constructed in such a manner that the data stored therein are regularly deleted from the central memory and are read in again from the passive storage means. However, it is also possible that the central memory is constructed for regularly checking the configuration for changes and correspondingly adapting the stored data, either due to an exchange or the addition or removal of a component.

Archiving means that the data read out are stored in this memory and are also kept available beyond a change in the configuration. The memory for archiving preferably provides adequate capacity for archiving the configuration data accrued over the entire life cycle of the aircraft.

The passive storage means are preferably RFID (Radio Frequency Identification) tags. RFID tags are known in the prior art and provide for the permanent storage of data written thereon by means of suitable electromagnetic writing devices. The stored data can be parts number, serial number, state of modification, manufacturing, installation and maintenance data, the version number of software which may be installed on the removable part and the like. The RFID tag is preferably embedded in the parts label so that during the manufacturing process of the removable part, information is preferably written onto the parts label at the same time and can be read into the passive storage means. The information located in the passive memory is preferably stored in digital form and also preferably encrypted, for example by means of a 128-bit encryption. The storage capacity of the digital passive storage means can be, for example, 300 to 500 bytes.

Data are preferably read into the passive storage means for the first time during the manufacturing process of the removable part, other reading-in processes can be carried out during each maintenance and/or modification of the corresponding removable part. In this manner, the passive storage means contains a history which is current at any time, and the actual state of the removable part.

A transmitting device for transmitting the data from the central memory to a memory arranged outside the aircraft is provided on board the aircraft. Such a transmitting device can operate in a wire-connected manner, for example by means of a corresponding line connection when the aircraft is parked at the gate. However, it is preferably a wireless connection which can use conventional standard radio transmission protocols such as, for example, mobile radio protocols (UMTS or GPRS) or the WLAN protocol. During the data transmission, standardized protocols such as, for example, the IP protocol can also be used.

The preferred encryption of the data stored in the passive storage means prevents the unauthorized reading-out and particularly the unauthorized manipulation of these data.

In a preferred embodiment of the invention, the reading device on board the aircraft is configured for automatically reading out the passive storage means in defined operating states of the aircraft. Automatic reading out means that the reading process is carried out by the at least one reading device without manual intervention (such as, for example, manually passing a reading device past the removable parts) and is preferably triggered automatically in defined operating states. Such a defined operating state can be, for example, the after-landing roll of the aircraft. The reading-out of RFID tags, which is critical with regard to the electromagnetic compatibility of the aircraft electronics, with reading devices sending out active electromagnetic radiation is not carried out during the flight condition which is critical with regard to the EMI compatibility but in the comparatively unproblematic state of after-landing roll before docking at the gate. This procedure has the great advantage that a complete picture of the actual state of the removable parts is continuously acquired and stored during aircraft operation (after each landing). This allows a complete and continuous acquisition of the status and maintenance history of the aircraft. This actual state after each landing can then be deposited in the central memory of the aircraft and/or transferred to an external computer and possibly evaluated further.

It is particularly preferred if the central memory of the aircraft is additionally connected to means for acquiring operating and/or flight data of the aircraft. These can be data such as, for example, the flying hours, operating data of the engines and/or of parts of the cabin equipment and the like. Such linking of data read out of the passive storage means with other operating and/or flight data of the aircraft is particularly valuable since in many cases a warranty for aircraft and their equipment is granted for a particular number of flying hours. The linking of RFID data and other flight data provided according to the invention and the running documentation (for example with each after-landing roll process) provides a reliable and traceable database from which it can be derived whether a particular removable part is still within the warranty period after its manufacture or after its last maintenance, or not, for example in the case of damage.

It is particularly preferred if the linking of RFID data and other flight data described is also archived. Thus, it is possible to detect regularities in the case of a component failure and thus to possibly determine the actual cause of the failure. For example, a regular failure of a video screen of the in-flight entertainment system can point to a defective overvoltage protection component even though the latter may not reveal any direct malfunction.

The provided automatic read-out of RFID data and their linking to flight data leads to that the documentation about the configuration of an aircraft, which previously had to be created manually in a very complex manner, can be generated and evaluated virtually completely automatically. It is even possible to produce interactive documentation of the aircraft which represents the components of the aircraft in a basic or tree diagram—preferably sorted in accordance with levels. In this arrangement, the levels to be indicated can be preferably selected by the user himself. Neither do all information items relating to the components need to be directly visible in the diagram. It is preferred to show only a brief representation of the component in the diagram; all the available information relating to this component will then only appear after a component has been selected.

In a preferred embodiment of the invention, the central memory of the aircraft is constructed as database server. This means that it can autonomously edit the stored and archived information.

If removable parts are exchanged, this change in status or in the configuration of the aircraft is automatically detected and stored during the next RFID enquiry (that is to say, for example, after the next landing of the aircraft). The corresponding RFID enquiries can also be provided more frequently, for example also with each rolling before the start of an aircraft.

In the central memory, the RFID data and the additional flight data are preferably linked in such a form that a database is generated in which operating and/or flight data relevant to its operation are stored for each removable part provided with a passive storage means. When this database is created, the memory content of the passive storage means on the removable part itself is not changed. This is only done during maintenance or with an exchange of the corresponding removable part.

During the production of the removable part, all invariable information relating to the removable part, for example, can be stored in the RFID tag. These are, for example, parts number, serial number, production date and the like. When the removable part is installed in the aircraft, the RFID tag is then written to again, for example with the installation date. This is done by the technician installing the removable part, using a corresponding mobile writing device.

Using this writing device, a service technician will always update the information in the RFID chip when the removable part is removed from the aircraft for maintenance purposes, maintenance or repair work is performed on it, new software is downloaded into it, the removable part is installed again or the like.

Independently of the updating of data in the individual RFID chip of each removable part, the preferred embodiments of the invention provide for an automatic acquisition of the overall configuration of the aircraft at predetermined times.

The central memory is preferably suitable for providing the data stored therein for an external access. The central memory can be constructed as web server by means of which the corresponding information can be made accessible in the Internet.

Apart from the data read out of the passive storage means, this web server can collect, edit and make available ready for retrieval all data of the aircraft relevant for maintenance or other purposes (that is also flight and operating data) on board. The web server on board the aircraft is temporarily connected to the Internet via a so-called mobile access router and its connections which are available depending on the operating state of the aircraft. Such a mobile access router automatically checks if and, if necessary, which connections are available for access to the Internet. In flight operation, these can be, for example, satellite connections and on the ground, they can be mobile radio connections as an alternative or additionally (for example UMTS or GPRS connections), WLAN connections or wire connections at the gate.

Since the aircraft cannot be connected permanently to the Internet, the web server does not have to have a fixed IP address. As soon as the aircraft is connected to the Internet, an IP address can first be assigned to the web server of the aircraft via a DNS to go server known in the prior art and from this moment on, the aircraft is visible in the Internet under its domain.

To evaluate the maintenance data, no further infrastructure is now required on the ground. The aircraft can be accessed (after corresponding authorization) via any Internet access and the data collected and edited on the web server on board can be read out.

The invention thus makes it possible that the current status of an aircraft can be retrieved via the Internet. To prepare maintenance of the aircraft, the current status can thus be interrogated via any Internet access and a corresponding documentation can be read or still created, if necessary.

It is particularly preferred if the component maintenance manuals of all components currently or formerly installed are kept available in the central memory, in a further memory on board the aircraft or an external memory accessible via the Internet. In the case where the manuals are stored on board, it is preferably provided that missing manuals are loaded from the Internet and added to the stored library. If thus a new component previously not used is installed in the aircraft, the library updates itself by itself. As a result, the entire documentation about the aircraft is always available on board the latter. In the context of the invention, it is possible to store, instead of the documents themselves, only links (for example Internet hyperlinks) to the documents in the database.

If the data of the individual components are stored in an autonomous database on board the aircraft, the central memory is preferably arranged in such a manner that so-called job cards can be created. These job cards are maintenance orders which are carried out by qualified staff members. The job cards can be created individually for each component on the basis of the maintenance periods predetermined by the manufacturer. However, it is particularly advantageous if empirical values, which can be obtained from the archived data in the central memory, are also included in the creation of the job cards. Thus, for example, it may happen that a component regularly fails before the maintenance period provided by the manufacturer has elapsed in the case of a special aircraft or aircraft type. Recognizing this phenomenon by means of the archived data makes it possible to individually adapt the maintenance period for this component.

The job cards can be created electronically and, for example, copied to hand-held PCs of the maintenance technicians. After the maintenance work has been completed, the electronic job cards can also be signed electronically and marked as completed in the central memory. However, it is also possible to exclusively or additionally print out the job cards on a printer permanently installed on board the aircraft or mobile. The job cards are then marked as completed by signature and/or stamp in the conventional manner. Depending on the type of maintenance work, the central memory can independently recognize the completion of the work since—as described above—the passive memory of the component to be maintained can be updated by the technician. However, there can also be a manual input that a job card has been processed completely.

In order to complete the records in the central memory on board the aircraft, it can be provided that the central memory can obtain information about newly installed components via the Internet. This can be manufacturer's data for which there is inadequate space in the passive storage means. However, it is also possible especially to provide a complete prehistory of the component. On the basis of this prehistory which, for example, can contain data about failures and/or maintenance work, the analysis of the aircraft configuration and/or the creation of individualized job cards can be improved further.

### BRIEF DESCRIPTION OF THE DRAWINGS

In the text which follows, an exemplary embodiment of the invention will be explained with reference to the drawing.

FIG. 1 depicts the arrangement of the invention.

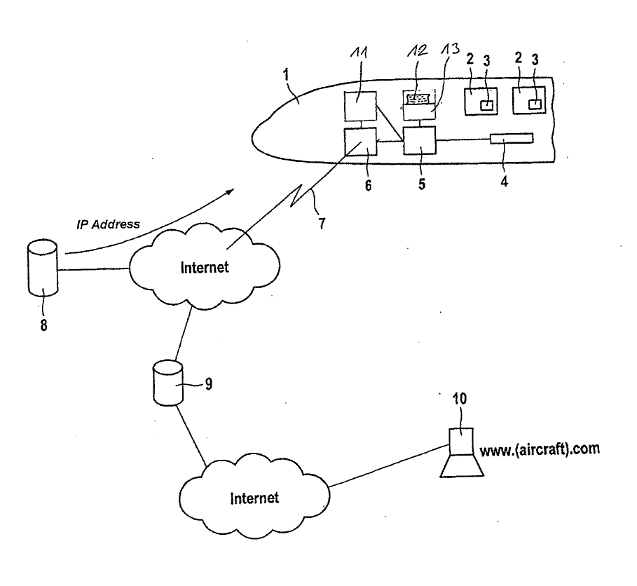

### DETAILED DESCRIPTION OF THE INVENTION

In an aircraft shown diagrammatically at 1, various removable parts 2 are arranged which are in each case provided with an RFID tag 3. In the RFID tag 3, relevant information about the removable part 2 such as, for example, parts number, serial number, date of manufacture, installation date, maintenance data, configuration data, version numbers of the recorded software (if relevant) etc. are stored. The stored information can only be read in or changed by authorized persons having special RFID writing devices which can handle the encryption selected for the storage.

An RFID reading device 4 is installed in the aircraft. Using this active reading device 4, the data can be read out of the RFID tags 3. Active means that this RFID reading device 4 sends out electromagnetic radiation and in doing so interacts with the RFID tags 3 and thus reads out the information stored in it. This is known in the prior art.

The range of conventional RFID reading devices is about 2 to 3 m. This means that, in practice, in the case of removable parts 2 distributed over relatively large areas of the aircraft, it may be required to arrange a number of RFID reading devices 4 in the aircraft. These RFID reading devices 4 should preferably be able to read all RFID tags 3 of the removable parts 2 without having to move them manually or the like.

The RFID reading device 4 is connected to a database server 5 constructed as web server. The web server 5 is connected to a so-called mobile access router 6. This mobile access router configures a connection of the web server 5 to the Internet via various connections depending on their availability. In flight operation, the mobile access router 6 can establish, for example, an Internet connection via a satellite network. On the ground, this can be done via mobile radio networks, WLAN or also via cable connections. The mobile access router 6 permanently checks which possible connections are available and selects them especially on the basis of the criteria of costs and required bandwidth.

At 7, the (as a rule wireless) connection with the Internet established via the mobile access router 6 is indicated.

The web server 5 is additionally connected to various sensors and control devices located on board the aircraft in order to acquire all relevant operating states and parameters of the aircraft.

Every time the aircraft rolls before the start and after a landing, the database server 5 activates the RFID reading device 4 and reads out the RFID tags 3. The corresponding information read out is stored in the database server 5. Pre-start roll or after-landing roll is considered as time for reading out the RFID tags since, on the one hand, there is no operating state (flight operation) which is critical with regard to electromagnetic compatibility and, on the other hand, during rolling, there is no possibility that maintenance work is performed and during this work the configuration is possibly changed in the course of the reading-out process. If a removable part 2 has been maintained or exchanged before the start, this change in configuration of the aircraft is detected during the pre-start roll and stored in the database server 5.

The database server 5 links the data read out of the RFID tags 3 with the flight data so that, for example, the flying hours flown can be stored in the database, and read out, for each removable part.

On the server 5, a database is thus kept available which contains all data of the removable parts 2 provided with RFID tags 3, which are required for documentation and maintenance purposes.

To complete the records, a memory 11 is provided for the component maintenance manuals of all removable parts 2 located in the aircraft which are equipped with RFID tags 3. The memory 11 is connected to the Internet via the mobile access router 6 and can download from there any missing manuals and add them to the deposited library.

In the memory 11, there is also a parts library. This contains information provided in the Internet and downloaded from there comprising the respective prehistory of each component.

The database server 5 is constructed as web server and thus it is possible to retrieve via the Internet all data made available there. For this purpose, the database server 5 is connected to the Internet via the mobile access router 6 and the connection indicated at 7 (for example satcom connection). Since the connection to the Internet cannot be permanent, the web server 5 cannot have a fixed IP address. As soon as an Internet connection exists, the web server 5 is assigned an IP address via the main server 8 of the Internet provider and the so-called DNS to go server 9 links this IP address to the domain of the aircraft. Under this domain, the aircraft is now accessible from each computer 10 connected to the Internet. Corresponding security mechanisms are provided so that only authorized persons can log into the web server 5. This is used for documenting the state of the aircraft, for example, for supervisory authorities or before maintenance. Maintenance can thus be accurately planned and spare parts required can be ordered and provided.

For the maintenance itself, it is provided to print out job cards 12 generated by the server 5. For this purpose, a correspondingly suitable printer 13 is provided on board the aircraft 1. The job cards can be generated by the server 5 on the basis of all available data. Apart from the data collected by itself such as, e.g., parts number and number of flying hours, the prehistory and the component maintenance manuals, which are available in the memory 11, can also be included.

1-10. (canceled)

11. A system for documenting the status of removable parts on board an aircraft, in which at least some of the removable parts comprise a passive storage to which and from which data can be read in a contactless manner, the system comprising:
a) at least one reading device contactlessly reading data from the passive storage is provided on board the aircraft,
b) at least one central memory provided on board the aircraft for storing or archiving the data which have been read from the passive storage by the at least one reading device, the central memory of the aircraft being connected to means for acquiring operating or flight data of the aircraft, and
c) a transmitting device on board the aircraft for transmitting the data from the central memory to a memory located outside the aircraft.

12. The system of claim 11, wherein the passive storage comprises RFID tags.

13. The system of claim 11 or 12, wherein the reading device on board the aircraft is configured for automatically reading out the passive storage in defined operating states of the aircraft.

14. The system of claim 13, wherein the defined operating states comprise an after-landing roll.

15. The system of claim 14, wherein the operating or flight data comprise flying hours.

16. The system of claim 11 or 12, wherein the central memory of the aircraft or a memory arranged outside the aircraft is configured to generate a database in which operating or flight data relevant to operation of the aircraft are stored for each removable part provided with the passive storage.

17. The system of claim 16, wherein the central memory of the aircraft or the memory arranged outside the aircraft is configured to store component maintenance manuals of the removable parts, data on a prehistory of each removable part or links to the manuals or data on the prehistory.

18. The system of claim 17, wherein the central memory of the aircraft or the memory arranged outside the aircraft is connected to a data processing device for automatically generating maintenance orders on the basis of the stored data.

19. The system of claim 11 or 12, wherein the central memory of the aircraft is constructed as database server.

20. The system of claim 18, wherein the database server is constructed as web server.
